(19) United States
(12) Patent Application Publication
(10) Pub. No.: US 2010/0206091 A1
(43) Pub. Date: Aug. 19, 2010

(54) APPARATUS FOR MEASURING COMPONENTS OF A POINT FORCE

(75) Inventors: Arie Ariav, Doar-Na Hof Ashkelon (IL); Vladimir Ravitch, Ashkelon (IL)

Correspondence Address: MARTIN D. MOYNIHAN d/b/a PRTSI, INC., P.O. BOX 16446, ARLINGTON, VA, 22215, US

(73) Assignee: Nexense Ltd., Yavne (IL)

(21) Appl. No.: 12/707,763

(22) Filed: Feb. 18, 2010

Related U.S. Application Data
(60) Provisional application No. 61/153,661, filed on Feb. 19, 2009.

(51) Int. Cl. G01L 5/00

(52) U.S. Cl. 73/862.041

(57) ABSTRACT

Apparatus for measuring components of a point force includes a first rigid member having an outer surface to receive the point force to be measured, and three spherical force transmitting elements, each of spherical or partial-spherical configuration, projecting from its inner surface, and a second rigid member having an inner surface facing the inner surface of the first member and formed with three sockets for receiving the three spherical force transmitting elements, each of the sockets includes two planar walls diverging in the direction towards the inner surface of the second member so as to be engaged by the respective spherical force transmitting element of the first member at two contact points, and to space apart the inner surfaces of the first and second members. A force sensor is located at each of the two contact points of each of the spherical force transmitting elements to sense the force applied by the respective spherical force transmitting element to each of the two planar surfaces of the second member.

### RELATED APPLICATION/S

This application claims the benefit of priority of U.S. Provisional Patent Application No. 61/153,661, filed on Feb. 19, 2009, the contents of which are incorporated herein by reference.

### FIELD AND BACKGROUND OF THE INVENTION

The present invention relates to apparatus for measuring components of a point force, and particularly the magnitude of the point force along the x, y and z axes, respectively, as well as the location of the point force with respect to the x and y axes.

There are many applications where it is necessary or desirable to measure the various components of a force applied at a point to determine the magnitude of the force along each of the X, Y and Z axes, as well as the location of the applied force with respect to the X and Y axes. As an example, such measurements are frequently necessary or desired with respect to implanted orthopedic sensors, such as described in U.S. Pat. No. 6,447,448, assigned to Ball Semiconductor, Inc., or in PCT Application No. PCT/IL2007/000935, published on Jan. 31, 2008 as Publication No. WO 2008/012820 and assigned to the same assignee as the present invention. Obtaining such measurements is extremely difficult when using known techniques, particularly where the measurements are to be made with respect to implanted orthopedic devices such as described in the above two prior art publications.

### OBJECT AND BRIEF SUMMARY OF THE PRESENT INVENTION

An object of the present invention is to provide apparatus for measuring components of a point force, which apparatus can be implemented in a relatively compact form making it particularly suitable for implanted orthopedic devices, but also suitable for many other applications.

According to one aspect of the present invention, there is provided apparatus for measuring components of a point force, comprising a first rigid member having an outer surface to receive the point force to be measured, and an inner surface carrying three spherical force transmitting elements each of spherical or partial-spherical configuration projecting from the inner surface of the first rigid member; a second rigid member having an inner surface facing the inner surface of the first rigid member and formed with three sockets for receiving the three spherical force transmitting elements; each the socket including at least two planar walls diverging in the direction towards the inner surface of the second rigid member so as to be engaged by its respective spherical force transmitting element of the first rigid member at two contact points, and to space apart the inner surfaces of the first and second rigid members; and a force sensor at each of the two contact points of each of the spherical force transmitting elements to sense thereat the force applied by the respective spherical force transmitting element to each of the two planar surfaces of the second rigid member.

In the described preferred embodiment, the inner surfaces of the first and second rigid members are planar. Preferably, the two rigid members are in the form of circular disks.

As will be described below, such apparatus may be implemented in a highly compact form particularly suitable for measuring the X, Y and Z coordinate components of a point force applied to the first member, and also the X and Y components of the location of the point force with respect to the center of the rigid member subjected to the point force.

Further features and advantages of the invention will be apparent from the description below.

### BRIEF DESCRIPTION OF THE DRAWINGS

The invention is herein described, by way of example only, with reference to the accompanying drawings, wherein:

FIGS. 1 and 2 pictorially illustrate two views of two rigid members in the form of circular disks constructed in accordance with the present invention for measuring the components of a point force applied to one of the members;

FIG. 3 is a diagram illustrating the force distribution pattern of the forces produced between the top disk and the bottom disk in FIGS. 1 and 2; and

FIG. 4 is a diagram of the forces produced along section A-A of FIG. 3, and how such forces are measured.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF A PREFERRED EMBODIMENT

The preferred embodiment of the invention described below is based on building a mechanical loading system which will transform a force applied to the upper surface of the loading system, represented by a force point vector, into measurable forces at a plurality of support points on the lower surface of the loading system. For this purpose, the upper surface receiving the applied force, represented as a linear vector, is on a first rigid member supported at a plurality of points on its lower surface over a second rigid member, such that the number of unknown forces to be measured is equal to the number of independent equilibrium conditions. The applied force will thus generate, in the underlying rigid member, constraint forces which may be calculated on the basis of six equilibrium conditions without using additional information of body rigidity.

The pressure distribution of the applied force may be represented by a single force vector applied at a particular location and angle to the upper rigid surface of the support system. Such a force thereby produces six unknown but measurable force values, namely: the three coordinate components of the applied force magnitude, and the three coordinate components of the applied force location. The apparatus constructed in accordance with the invention described below enables the measuring of the three components (projections on the X, Y and Z axes) of applied force magnitude, and the X and Y coordinate components of the applied force center.

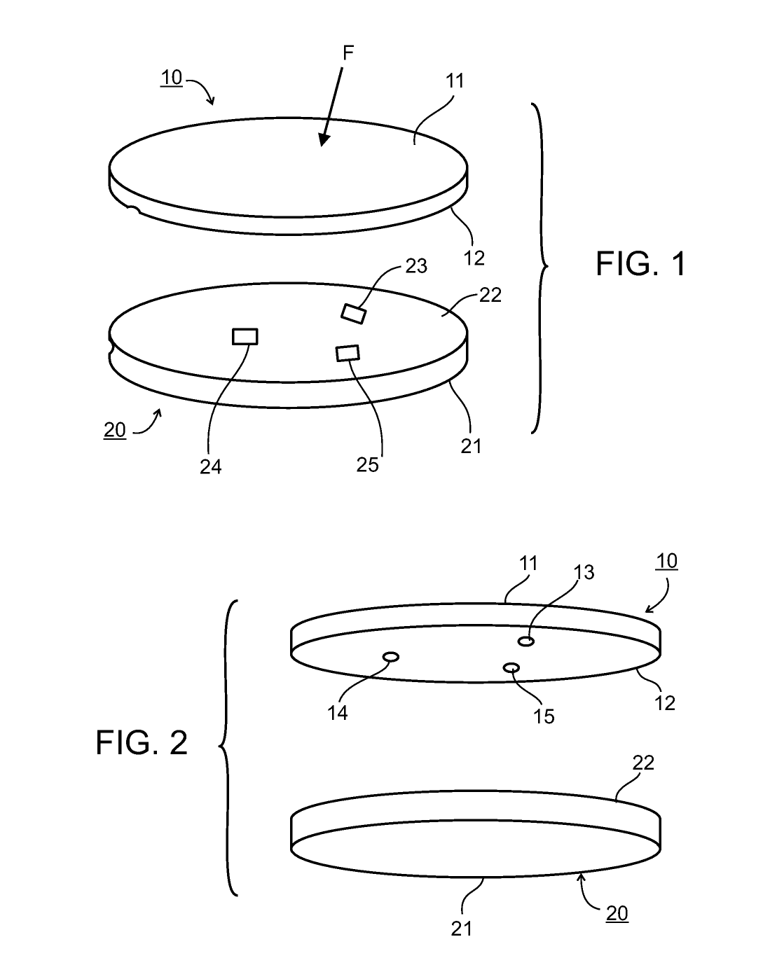

FIGS. 1 and 2 are two views illustrating a support system constructed in accordance with the present invention for measuring both the three components (X, Y and Z axes projections) of the force magnitude, and the two coordinates (X and Y axes) of the location of a point force represented by a force vector applied to the supper surface of the support system.

Thus, as seen in FIG. 1, the support system comprises two rigid circular disks 10, 20, each having an outer surface 11, 21, respectively, and an inner surface 12, 22, respectively, with the two inner surfaces facing each other. The outer surface 11 of disk 10 receives the applied force, as represented by force vector F. The system, as described below, transforms the applied force F into force magnitude components along the three coordinate axes, X, Y, Z, and the two location components along the X and Y coordinate axes.

For this purpose, the inner surface 12 of the upper disk 10, receiving the applied force F, includes three spherical force transmitting elements 13, 14, 15, projecting from the inner surface 12 and symmetrically arranged around the center of the disk. In addition, the inner surface 22 of the lower disk 20 is formed with a similar symmetrical array of recesses or sockets 23, 24, 25, effective to receive the force transmitting elements of the upper disk 10 and to transmit such forces to the lower disk 20.

In the example illustrates in FIGS. 1 and 2, each of the force transmitting elements 13, 14, 15 is a spherical ball received within a spherical socket formed in the inner surface of the upper disk 10. In some applications it may be desirable to provide such spherical force transmitting elements in the form of a partial spherical surface internally formed in the inner surface of the upper disk 10. In either case such force transmitting elements are effective to space the two disks apart.

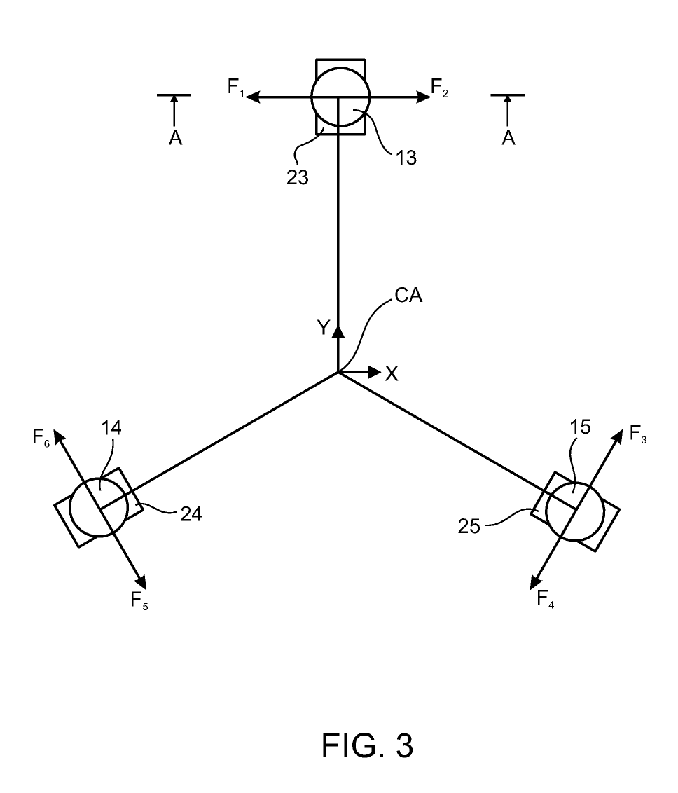

FIG. 3 diagrammatically illustrates the distribution of the forces transmitted from each of the three spherical force transmitting elements 13-15 of the upper disk 10 to the lower disk 20 via the sockets 23-25 in the lower disk. As seen in FIG. 3, the three force transmitting elements 13-15 of the upper disk, and the three sockets 23-25 of the lower disk, are symmetrically arrayed around the center axis CA of the two disks 10, 20. As will be described more particularly below, the support system, including the two disks 10, 20, convert the applied force F (FIG. 1) into its force magnitude components along the three coordinates X, Y, Z axes, and its location components along the X-axis and Y-axis, with respect to the center axis CA of the two disks 10, 20.

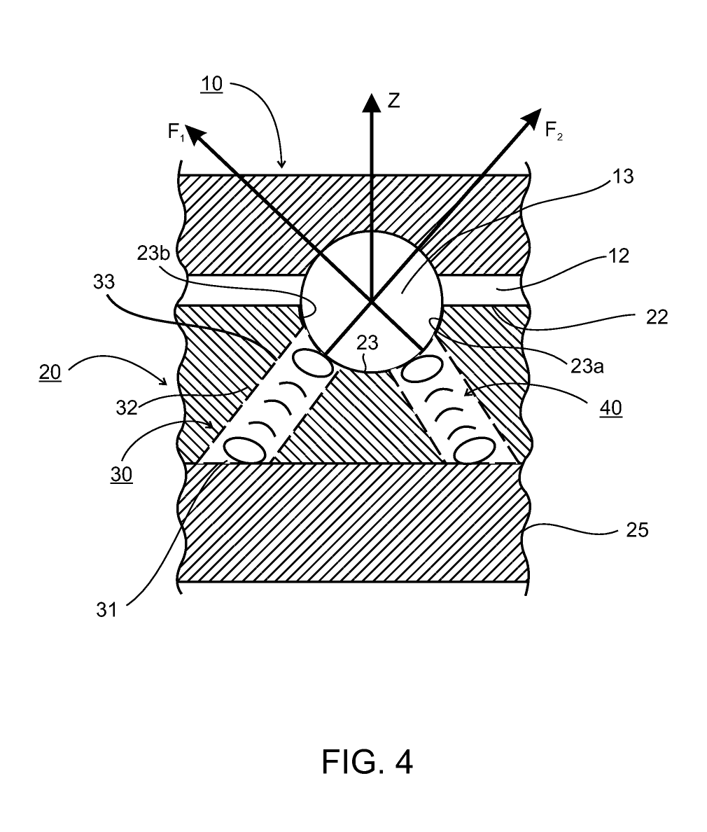

FIG. 4 illustrates the force distribution produced by the force transmitting element 13 carried by the inner surface of the upper disk 10 and received within socket 23 formed in the inner surface of the underlying disk 20. As seen in FIG. 4, the force transmitting element 13 is seated in a socket 23 which includes two planar surfaces 23a, 23b, diverging in the direction of the inner surface 22 of disk 20. It will be seen that in such an arrangement, the two planar surfaces 23a, 23b of socket 23 are engaged by the force transmitting element 13 at two contact points.

The dimensions of the spherical force transmitting elements 13-15 are such as to space the overlying disk 10 from the inner surface of the underlying disk 20, so that the total force transmitted by force transmitting elements 13-15 to the underlying disk 20 are restricted to the two contact points of each spherical force transmitting element 13 (e.g., with respect to the planar wall 23a, 23b of socket 23). For purposes of convenience, FIG. 4 illustrates the lower disk 20 as being mounted on a supporting base generally designated 25.

As further shown in FIG. 4, a force sensor, generally designated 30, 40, is provided to sense and measure the forces applied by each of the spherical force transmitting elements 13-15 to each of the two planar walls (e.g., 23a, 23b) via the two contact points of each force transmitting element with respect to each of the sockets 23-25. Any known type of force sensor may be used for force sensors 30, 40, e.g. strain gauges, etc. Preferably, however, an acoustical-type force sensor is used of the type described in above-cited PCT Patent Application No. PCT/IL2007/000935, International Publication No. WO 2008/012820.

With reference to sensor 30 illustrated in FIG. 4, such a sensor includes an acoustical transmitter 31 and an acoustical receiver 32 spaced from transmitter 31 so as to define an acoustical transmission channel 33 between the two. The transmitter 31 and receiver 32 are located such that the acoustical transmission channel 33 between the two is aligned with the contact point of spherical force transmitting element 13 with respect to planar wall 23a and is perpendicular to that wall. The force produced at this contact point with wall 23a will vary the transit time of an acoustical wave transmitted from transmitter 31 to receiver 32 via acoustical transmission channel 33. Therefore this force may be measured by measuring this transit time.

The above-cited patent application of Publication No. WO 2008/012820 describes a specific system for precisely measuring this transit time of the acoustical wave. For the sake brevity, this system is not described herein, but rather the complete disclosure of this international patent application is incorporated herein by reference for this purpose.

FIG. 4 represents the forces, which act on the top disk 10 from the constraints of the bottom disk 20. All forces \vec{F}₁ . . . \vec{F}₆ are placed on the angle π/4 in regard to the horizontal plan. The forces \vec{F}₃ . . . \vec{F}₄ and \vec{F}₅ . . . \vec{F}₆ are rotated on the angle π/6 in regard to X axis.

Let an arbitrary force vector [F_{X} F_{Y}F_{Z}] be applied to the top disk on an arbitrary point [x₀y₀] of its top surface. At static equilibrium, the forces \vec{F}₁ . . . \vec{F}₆ and the forces F_{X}, F_{Y} and F_{Z} become balanced.

The followed set of equations may be written

$${F}_{X} = cos ( π / 4 ) \cdot [ ( {F}_{1} - {F}_{2} ) + sin ( π / 6 ) \cdot ( ( {F}_{4} - {F}_{3} ) + ( {F}_{5} - {F}_{6} ) ) ]$$

$${F}_{Y} = cos ( π / 4 ) \cdot cos ( π / 6 ) \cdot ( ( {F}_{3} - {F}_{4} ) + ( {F}_{6} - {F}_{5} ) )$$

$${F}_{Z} = cos ( π / 4 ) \cdot ( {F}_{1} + {F}_{2} + {F}_{3} + {F}_{4} + {F}_{5} + {F}_{6} )$$

$${x}_{0} = \frac{\begin{matrix}cos ( π / 4 ) \cdot cos ( π / 6 ) \cdot ( ( {F}_{3} + {F}_{4} ) - \\ ( {F}_{5} + {F}_{6} ) ) \cdot R + {F}_{X} \cdot h\end{matrix}}{{F}_{Z}}$$

$${y}_{0} = \frac{\begin{matrix}cos ( π / 4 ) \cdot ( ( {F}_{1} + {F}_{2} ) - sin ( π / 6 ) \cdot \\ ( ( {F}_{3} + {F}_{4} ) + ( {F}_{5} + {F}_{6} ) ) ) \cdot R + {F}_{Y} \cdot h\end{matrix}}{{F}_{Z}}$$

wherein: (F₁, F₂), (F₃, F₄), and (F₅, F₆) are the forces measured at the two contact points of the respective one of said three spherical force transmitting members.

Where R—horizontal distance between the disk center and each sphere center;

h—vertical distance between the disk top surface and each sphere center;

x₀, y₀—position of the center the forces applied to the top surface.

Thus, if forces \vec{F}₁ . . . \vec{F}₆ are measured, it is possible to calculate the resultant force vector [F_{X} F_{Y}F_{Z}] and its location as applied to the top surface.

It has been found that the above-described arrangement provides very good repeatability when the two parts (disks 10, 20) are disassembled and reassembled many times. Thus, in the described construction, it has been found that the six contact points enable very good repeatability when the two disks are disassembled and reassembled. In addition, the friction between the spherical force transmitting elements 13-15 and the flat or planar wall surfaces (e.g., 23a, 23b) of the sockets 23-25 is very low. The resultant force and torque may thus be precisely measured by measuring the forces at the above-described contact points alone.

As noted above, the bottom disk 20 should be fixed along the X and Y axes, e.g. by fixing or implanting the bottom disk 20 to the base plate 25, such that the top disk 10 has no contact with the base plate. Such a construction thus permits all the force applied to top disk 10 to be transmitted to the bottom disk 20 via the six contact points described above.

While the invention has been described above with respect to one preferred embodiment, it will be appreciated that this is set forth merely for purposes of example, and that many variations may be made. For example, in some applications, the top disk may include a smaller number, or a larger number, of the spherical force transmitting elements 13-15 received in a corresponding number of sockets in the bottom disk 20. Also, in some applications, it may be desired to provide each socket with more than two planar walls, e.g. to produce a correspondingly larger number of force transmitting contact points between the two disks.

Many other variations, modifications and applications of the invention will be apparent.

What is claimed is:

1. Apparatus for measuring components of a point force, comprising:
a first rigid member having an outer surface to receive the point force to be measured, and an inner surface carrying three spherical force transmitting elements each of spherical or partial-spherical configuration projecting from said inner surface of the first rigid member;
a second rigid member having an inner surface facing the inner surface of said first rigid member and formed with three sockets for receiving said three spherical force transmitting elements;
each of said sockets including at least two planar walls diverging in the direction towards said inner surface of the second rigid member so as to be engaged by its respective spherical force transmitting element of the first rigid member at least at two contact points, and to space apart said inner surfaces of the first and second rigid members;
and a force sensor at each of said two contact points of each of each of said spherical force transmitting elements to sense thereat the force applied by the respective spherical force transmitting element to each of said two planar surfaces of the second rigid member.

2. The apparatus according to claim 1, wherein said three spherical force transmitting elements carried by said first rigid member, and said three sockets formed in the second rigid member, are symmetrically arrayed around the center of the respective rigid member.

3. The apparatus according to claim 2, wherein said planar surfaces of each socket are perpendicular to each other; and wherein the magnitudes of the force components (Fₓ, F_{y}, F_{z}) of the applied point force along the x, y and z axes are determined as follows:
F_{X}=cos(π/4)·[(F₁−F₂)+sin(π/6)·((F₄−F₃)+(F₅−F₆))]
F_{Y}=cos(π/4)·cos(π/6)·((F₃−F₄)+(F₆−F₅))
F_{Z}=cos(π/4)·(F₁+F₂+F₃+F₄+F₅+F₆)
wherein: (F₁, F₂), (F₃, F₄), and (F₅, F₆) being the forces measured at the two contact points of the respective spherical force transmitting element.

4. The apparatus according to claim 3, wherein the location of the force components along the x and y axes (xₒ, yₒ) are determined as follows:
$${x}_{0} = \frac{cos ( π / 4 ) \cdot cos ( π / 6 ) \cdot ( ( {F}_{3} + {F}_{4} ) - ( {F}_{5} + {F}_{6} ) ) \cdot R + {F}_{X} \cdot h}{{F}_{Z}}$$
$${y}_{0} = \frac{cos ( π / 4 ) \cdot ( \begin{matrix}( {F}_{1} + {F}_{2} ) - sin ( π / 6 ) \cdot \\ ( ( {F}_{3} + {F}_{4} ) + ( {F}_{5} + {F}_{6} ) )\end{matrix} ) \cdot R + {F}_{Y} \cdot h}{{F}_{Z}}$$
where, R is the horizontal distance between the disk center and each sphere center; and
h is the vertical distance between the disk top surface and each sphere center; and
x₀,y₀ are the position of the center the forces applied to the top surface.

5. The apparatus according to claim 1, wherein each of said first and second rigid members is of a circular disk shape.

6. The apparatus according to claim 1, wherein each of said force sensors includes an acoustical transmitter an acoustical receiver defining an acoustical wave transmission channel between it and the acoustical transmitters.

7. The apparatus according to claim 1, wherein each of said force sensors includes an acoustical transmitter, an acoustical receiver defining an acoustic wave transmission channel between it and the acoustical transmitters, and a measuring circuit for measuring the transit time of an acoustical wave transmitted from said transmitter to said receiver via the respective acoustical transmission channel.
